(19) United States
(12) Patent Application Publication
(10) Pub. No.: US 2014/0370277 A1
(43) Pub. Date: Dec. 18, 2014

(54) ADHESIVE COMPOSITION FOR OPTICAL APPLICATIONS, ADHESIVE LAYER FOR OPTICAL APPLICATIONS, OPTICAL MEMBER, POLARIZING PLATE, AND IMAGE DISPLAY DEVICE

(71) Applicants: Masatsugu Higashi, Ibaraki-shi (JP); Yutaka Moroishi, Ibaraki-shi (JP); Shigeru Fujita, Ibaraki-shi (JP); Tetsuo Inoue, Ibaraki-shi (JP)

(72) Inventors: Masatsugu Higashi, Ibaraki-shi (JP); Yutaka Moroishi, Ibaraki-shi (JP); Shigeru Fujita, Ibaraki-shi (JP); Tetsuo Inoue, Ibaraki-shi (JP)

(73) Assignee: NITTO DENKO CORPORATION, Ibaraki-shi, Osaka (JP)

(21) Appl. No.: 14/241,563

(22) PCT Filed: Aug. 20, 2012
(86) PCT No.: PCT/JP2012/070982

§ 371 Date: Feb. 27, 2014

(30) Foreign Application Priority Data
Aug. 29, 2011 (JP) 2011-186060

(51) Int. Cl. C09J 151/00; G02B 1/10; G02B 5/30; G02B 1/04

(52) U.S. Cl. CPC C09J 151/003; G02B 1/04; G02B 1/105; G02B 5/305
USPC 428/345; 428/355 AC; 428/354; 428/349; 525/286; 522/126

(57) ABSTRACT

The purpose of the present invention is to provide: an adhesive composition for optical applications, which is capable of suppressing luminance unevenness without deteriorating the contrast characteristics in optical applications, and which can be used for optical members and prevents the optical members from separation in a reliability test; an adhesive layer; an optical member; an image display device and the like. An adhesive composition for optical applications, which contains a modified (meth)acrylic graft polymer and an isocyanate crosslinking agent, is prepared. The modified (meth)acrylic graft polymer is obtained by graft polymerizing chains, each of which contains a cyclic ether group-containing monomer, to the trunk polymer, and contains, as constituent components, an alkyl(meth)acrylate, a cyclic ether group-containing monomer, and an acyclic ether group-containing monomer. An adhesive layer for optical applications, which is formed from the composition, an optical member, an image display device and the like are also produced.

### TECHNICAL FIELD

The present invention relates to an adhesive (pressure-sensitive adhesive and adhesion bond) composition and an adhesive layer for an optical member, an optical member on which an adhesive layer is laid, a polarizing plate on which an adhesive layer is laid, and an image display device with such an optical member.

### BACKGROUND ART

In a liquid crystal display device, optical members used therein, for example, a polarizing plate and a retardation plate are bonded to a liquid crystal cell by use of an adhesive. The liquid crystal display device has a problem that when this display device is exposed to a heating and humidifying environment for a predetermined period and then its backlight is turned on to give a black display, the display device becomes uneven in brightness to be lowered in viewability. Such problems can be caused by a matter that when the liquid crystal gives a display, the polarizing plate is shrunken by heat from the backlight and the shrinkage causes a shift of the axis of the polarizer, or a shift of the axis of the retardation plate to generate the unevenness.

For decreasing such an axis shift or unevenness, it has been hitherto conceived that the adhesive is made high in elastic modulus. However, such a liquid crystal display device has a problem that when the adhesive is made high in elastic modulus, the adhering strength at the interface between the adhesive and one or more adherends is lowered so that the optical member(s) is/are readily peeled off when the display device is heated and humidified.

So far, as an adhesive having a high resistance against such peeling off, for example, an optically curable adhesive has been suggested which contains a modified (meth)acryl-based graft polymer obtained by graft-polymerizing a chain that contains a cyclic-ether-group-containing monomer (Patent Document 1). However, there may be caused a problem that the compatibility is low in accordance with an article in which the adhesive is used.

### PRIOR ART DOCUMENT

### Patent Document

Patent Document 1: JP-A-2010-138370

### SUMMARY OF THE INVENTION

### Problems to be Solved by the Invention

An object of the present invention is to provide an excellent adhesive composition for optical applications that can decrease an unevenness in brightness of a device, such as an image display device, by restricting the movement of its optical member, and that rarely causes peeling off of the optical member even in a heating and humidifying environment.

Another object of the invention is to provide an adhesive layer for optical applications that are each formed by use of the adhesive composition for optical applications, an adhesive layer attached optical member, and a polarizing plate and an image display device containing any one of these matters.

### Means for Solving the Problems

In order to solve the above-mentioned problems, the inventors have made eager investigations to find out an adhesive composition described below for optical applications. Thus, the invention has been achieved.

The present invention relates to an adhesive composition for optical applications, comprising 100 parts by weight of a modified (meth)acryl-based graft polymer, and 0.01 to 1.80 parts by weight of an isocyanate crosslinking agent,

wherein the modified (meth)acryl-based graft polymer is obtained by graft-polymerizing, to its backbone polymer, a chain that contains a cyclic-ether-group-containing monomer, and comprises an alkyl(meth)acrylate, the cyclic-ether-group-containing monomer, and an acyclic-ether-group-containing monomer as constituent components, and

in the modified (meth)acryl-based graft polymer, the acyclic-ether-group-containing monomer is contained in an amount of 8 to 40 parts by weight for 100 parts by weight of the whole of the monomer components that constitute the backbone polymer and are different from the acyclic-ether-group-containing monomer.

As for the above-mentioned modified (meth)acryl-based graft polymer, the acyclic-ether-group-containing monomer is preferably contained in the backbone polymer.

Preferably, the above-mentioned composition may further comprise a photopolymerization initiator in an amount of 0.05 to 10 parts by weight or a thermosetting catalyst in an amount of 0.05 to 10 parts by weight based on 100 parts by weight of the modified (meth)acryl-based graft polymer.

Preferably, the composition may comprise a silane coupling agent in an amount of 0.01 to 5 parts by weight for 100 parts by weight of the modified (meth)acryl-based graft polymer.

The cyclic-ether-group-containing monomer contained in the chain is made from the cyclic-ether-group-containing monomer and one or more monomers different from the monomer, and the ratio of the amount of the cyclic-ether-group-containing monomer to the total amount of the different monomer(s) is from 90:10 to 10:90.

The modified (meth)acryl-based graft polymer may be obtained by graft-polymerizing, to 100 parts by weight of the backbone polymer, 2 to 50 parts by weight of the cyclic-ether-group-containing monomer in the presence of 0.02 to 5 parts by weight of a peroxide.

The present invention also relates to an adhesive layer for optical applications, which is obtained from the adhesive composition for optical applications that is recited in any of the above.

The present invention also relates to a cured adhesive layer for optical applications, which is obtained by radiating an active energy ray to or applying heating treatment to any of the above-mentioned adhesive layer for optical applications.

The gel fraction of the above-mentioned cured adhesive layer for optical applications may be 80 to 98% both inclusive.

Preferably, the gel fraction after the curing by the radiation of the active energy ray or the application of the heating treatment is preferably at least 6% higher than the gel fraction before the curing.

The haze of the above-mentioned cured adhesive layer for optical applications may be a haze of 2.0 or less.

The present invention also relates to an adhesive layer attached optical member, wherein the adhesive layer for optical applications or the cured adhesive layer for optical applications is laid on at least one side of an optical member.

The present invention also relates to an adhesive layer attached polarizing plate, which is formed by laying a protective layer, a polarizer, and the adhesive layer for optical applications or the cured adhesive layer for optical applications in turn into a lamination.

The present invention also relates to an adhesive layer attached polarizing plate, which is formed by laying a protective layer, a polarizer, a protective layer or a retardation layer, and the adhesive layer for optical applications or the cured adhesive layer for optical applications in turn into a lamination.

The present invention also relates to an image display device, which comprises the adhesive layer attached polarizing plate.

The present invention also relates to a lighting system, which comprises the adhesive layer attached optical member.

### Effect of the Invention

The adhesive composition for optical applications of the invention can provide adhesive layer for optical applications that can decrease an unevenness in brightness of a device, while maintaining a contrast characteristics of an image display device, that rarely causes peeling off of the optical member even in a heating and humidifying environment.

### MODE FOR CARRYING OUT THE INVENTION

The adhesive composition of the invention is an adhesive composition for optical applications, comprising 100 parts by weight of a modified (meth)acryl-based graft polymer, and 0.01 to 1.80 parts by weight of an isocyanate crosslinking agent, wherein the modified (meth)acryl-based graft polymer is obtained by graft-polymerizing, to its backbone polymer, a chain that contains a cyclic-ether-group-containing monomer, and comprises an alkyl(meth)acrylate, the cyclic-ether-group-containing monomer, and an acyclic-ether-group-containing monomer as constituent components, and

in the modified (meth)acryl-based graft polymer, the acyclic-ether-group-containing monomer is contained in an amount of 8 to 40 parts by weight for 100 parts by weight of the whole of the monomer components that constitute the backbone polymer and are different from the acyclic-ether-group-containing monomer.

Monomer units contained in the modified (meth)acryl-based graft polymer are each not particularly limited, and may each be any (meth)acrylate. Preferably, for example, an alkyl(meth)acrylate containing an alkyl group having 4 or more carbon atoms is contained in a proportion of 50 to 95% by weight of the whole of the modified (meth)acryl-based graft polymer.

In the present specification, the wording “alkyl(meth)acrylate” denotes a (meth)acrylate having a linear or branched alkyl group. The alkyl group has 4 or more carbon atoms, and preferably has 4 to 9 carbon atoms. (Meth)acrylate denotes acrylate and/or methacrylate. In the invention, “(meth)” in any word or wording has a meaning equivalent thereto.

Specific examples of the alkyl(meth)acrylate include n-butyl(meth)acrylate, s-butyl(meth)acrylate, t-butyl(meth)acrylate, isobutyl(meth)acrylate, n-pentyl(meth)acrylate, isopentyl(meth)acrylate, hexyl(meth)acrylate, heptyl(meth)acrylate, isoamyl(meth)acrylate, 2-ethylhexyl(meth)acrylate, n-octyl(meth)acrylate, isooctyl(meth)acrylate, n-nonyl(meth)acrylate, isononyl(meth)acrylate, n-decyl(meth)acrylate, isodecyl(meth)acrylate, n-dodecyl(meth)acrylate, isomyristyl(meth)acrylate, n-tridecyl(meth)acrylate, n-tetradecyl(meth)acrylate, stearyl(meth)acrylate, and isostearyl(meth)acrylate. Of these examples, n-butyl(meth)acrylate and 2-ethylhexyl(meth)acrylate are preferred. These may be used alone or in combination.

In the invention, the proportion of the alkyl(meth)acrylate in the entire monomer components for the modified (meth)acryl-based graft polymer is 50% or more by weight, preferably 55% or more by weight. The entire monomers may be one or more species of the alkyl(meth)acrylate. However, the proportion is preferably 95% or less by weight, more preferably 90% or less by weight.

In the invention, the acyclic-ether-group-containing monomer is not particularly limited about the species thereof, and is preferably a (meth)acrylate that contains an acyclic ether group. The monomer is preferably, for example, an acyclic-ether-group-containing alkoxyalkyl(meth)acrylate that contains, as its side alkyl group, a linear or branched alkoxyalkyl group but contains no cyclic ether group. Examples thereof include methoxyethyl(meth)acrylate, ethoxyethyl(meth)acrylate, methoxypropyl(meth)acrylate, ethoxypropyl(meth)acrylate, methoxybutyl(meth)acrylate, ethoxybutyl(meth)acrylate, methoxyhexyl(meth)acrylate, ethoxyhexyl(meth)acrylate, methoxyoctyl(meth)acrylate, ethoxyoctyl(meth)acrylate, methoxydecyl(meth)acrylate, and ethoxydecyl(meth)acrylate. These may be used alone or in combination. The acyclic-ether-group-containing monomer may be an acyclic-ether-group-containing monomer that contains an aromatic or alicyclic group, such as phenoxy(meth)acrylate, methoxyphenyl(meth)acrylate, or methoxycyclohexyl(meth)acrylate.

The acyclic-ether-group-containing monomer may be contained in the backbone polymer of the modified (meth)acryl-based graft polymer, or may be contained in one or more chains grafted thereto. This monomer may be contained in the two. In the invention, it is particularly preferred that the acyclic-ether-group-containing monomer is contained in the backbone polymer.

The acyclic-ether-group-containing monomer is contained in an amount of 8 to 40 parts by weight for 100 parts by weight of the monomers different from the acyclic-ether-group-containing monomer in the entire monomer components that constitute the trunk of the modified (meth)acryl-based graft polymer. When the acyclic-ether-group-containing monomer is contained only in the grafted chain region of the modified (meth)acryl-based graft polymer, the monomer is contained in an amount of 8 to 40 parts by weight for 100 parts by weight of the entire monomer components that constitute the backbone polymer.

It is preferred that the modified (meth)acryl-based graft polymer in the invention contains, besides the above, a hydroxyl-group-containing monomer that contains, in its alkyl group, at least one hydroxyl group. This monomer is a monomer containing a hydroxyalkyl group having one or more hydroxyl groups. The hydroxyl group(s) is/are preferably present at one or more terminals of the alkyl group. The number of the carbon atoms in the alkyl group is preferably from 2 to 8, more preferably from 2 to 6, even more preferably from 2 to 4. Such a hydroxyl-group-containing monomer is contained therein, whereby a favorable effect is produced onto a position where hydrogen is withdrawn at the time of the graft polymerization, or the compatibility between the graft polymer and a homopolymer made from the cyclic-ether-group-containing monomer, the homopolymer being generated at the graft polymerization time. Thus, it can be considered that the hydroxyl-group-containing monomer serves for making the prepared graft polymer good in heat resistance.

As this monomer, the following is usable without any especial restriction: a hydroxy(meth)acrylamide monomer having a polymerizable functional group having an unsaturated double bond of a (meth)acryloyl group, and having a hydroxyl group. Examples thereof include 2-hydroxyethyl(meth)acrylamide, 3-hydroxypropyl(meth)acrylamide, 4-hydroxybutyl(meth)acrylamide, 6-hydroxyhexyl(meth)acrylamide, 8-hydroxyoctyl(meth)acrylamide, 10-hydroxydecyl(meth)acrylamide, and other hydroxyalkyl(meth)acrylamides.

The proportion of the hydroxy(meth)acrylamide monomer is preferably 0.2% or more by weight, more preferably 0.5% or more by weight, and preferably 10% or less by weight of the whole of the monomer components that form the modified (meth)acryl-based graft polymer. The proportion is most preferably from 1 to 10% by weight.

It is also preferred that a cyclic-ether-group-containing monomer is copolymerized into the modified (meth)acryl-based graft polymer.

The cyclic-ether-group-containing monomer is not particularly limited, and is preferably an epoxy-group-containing monomer, an oxetane-group-containing monomer, or a combination of the two.

Examples of the epoxy-group-containing monomer include glycidyl acrylate, glycidyl methacrylate, 3,4-epoxycyclohexylmethyl acrylate, 3,4-epoxycyclohexylmethyl methacrylate, and 4-hydroxybutyl acrylate glycidyl ether. These may be used alone or in combination.

Examples of the oxetane-group-containing monomer include 3-oxetanylmethyl(meth)acrylate, 3-methyl-3-oxetanylmethyl(meth)acrylate, 3-ethyl-3-oxetanylmethyl(meth)acrylate, 3-butyl-3-oxetanylmethyl(meth)acrylate, and 3-hexyl-3-oxetanylmethyl(meth)acrylate. These may be used alone or in combination.

The proportion of the cyclic-ether-group-containing monomer is preferably 2% or more by weight, more preferably 3% or more by weight of the whole of the modified (meth)acryl-based graft polymer. The upper limit thereof is not particularly limited, and is preferably 40% or less by weight. When the proportion of the cyclic-ether-group-containing monomer is 3% or more by weight, the composition sufficiently exhibits a function as an adhesive. If the proportion is 40% or more by weight, the composition is reduced in tackiness so that the composition may not initially adhere with ease.

As one or more monomer components that form the modified (meth)acryl-based graft polymer, one or more different copolymerizable monomers may be used alone or in combination as far as the objects of the invention are not damaged.

The different copolymerizable monomer(s) is/are (each), for example, an aromatic-ring-containing monomer having a polymerizable functional group having an unsaturated double bond such as a (meth)acryloyl group or vinyl group, and having an aromatic ring. Specific examples of the aromatic-ring-containing monomer include phenoxyethyl(meth)acrylate, benzyl(meth)acrylate, phenolethylene oxide modified (meth)acrylate, 2-naphthethyl(meth)acrylate, 2-(4-methoxy-1-naphthoxy)ethyl(meth)acrylate, phenoxypropyl(meth)acrylate, phenoxydiethylene glycol(meth)acrylate, and polystyryl(meth)acrylate.

It is also preferred that the modified (meth)acryl-based graft polymer contains one or more of the following: acid-anhydride-group-containing monomers such as maleic anhydride, and itaconic anhydride; a caprolactone adduct of acrylic acid; sulfonate-group-containing monomers such as styrenesulfonic acid, allylsulfonic acid, 2-(meth)acrylamide-2-methylpropanesulfonic acid, (meth)acrylamide propanesulfonic acid, sulfopropyl(meth)acrylate, and (meth)acryloyloxynaphthalenesulfonic acid; phosphate-group-containing monomers such as 2-hydroxyethylacryloyl phosphate; and alkoxyalkyl(meth)acrylate monomers such as methoxyethyl(meth)acrylate, and ethoxyethyl(meth)acrylate; and the like.

Furthermore, one or more of the following are usable: vinyl monomers such as vinyl acetate, vinyl propionate, styrene, α-methylstyrene, and N-vinylcaprolactam; epoxy-group-containing monomers such as glycidyl(meth)acrylate, methylglycidyl(meth)acrylate, and 3,4-epoxycyclohexylmethyl(meth)acrylate; glycol acrylic ester monomers such as polyethylene glycol(meth)acrylate, polypropylene glycol(meth)acrylate, methoxyethylene glycol(meth)acrylate, and methoxypolypropylene glycol(meth)acrylate; acrylic acid ester monomers such as tetrahydrofurfuryl(meth)acrylate, fluoro(meth)acrylate, silicone(meth)acrylate, and 2-methoxyethyl acrylate; and amide-group-containing monomers, amino-group-containing monomers, imide-group-containing monomers, N-acryloylmorpholine, vinyl ether monomers, and the like.

The weight-average molecular weight of the modified(meth)acryl-based graft polymer in the invention is preferably 600,000 or more, more preferably from 700,000 to 3,000,000 both inclusive. The weight-average molecular weight denotes a value measured by GPC (gel permeation chromatography) and calculated out in terms of that of polystyrene.

The modified (meth)acryl-based graft polymer may be produced by selecting an appropriate known production method initially, examples thereof including solution polymerization, bulk polymerization, emulsion polymerization and various radical polymerizations, to prepare a backbone polymer, and then subjecting the polymer to graft polymerization. The resultant backbone polymer may be a random copolymer or a block copolymer.

In the solution polymerization, for example, ethyl acetate or toluene is used as a polymerization solvent. In a specific example of the solution polymerization, reaction therefor is conducted usually under reaction conditions that the reaction temperature is from about 50 to 70° C. and the reaction period is from about 5 to 30 hours in the presence of an added polymerization initiator under the flow of an inert gas such as nitrogen gas.

The polymerization initiator, the chain transfer agent, the emulsifier, and others that are each used in the radical polymerization are not particularly limited, and may be appropriately selected to be used. The weight-average molecular weight of the (meth)acryl-based polymer is controllable in accordance with the polymerization initiator, the amount of the chain transfer agent used, and conditions for the reaction. In accordance with the types of these, the amounts thereof to be used are appropriately adjusted.

Examples of the polymerization initiator include, but are not limited to, azo initiators such as 2,2′-azobisisobutyronitrile, 2,2′-azobis(2-amidinopropan)dihydrochloride, 2,2′-azobis[2-(5-methyl-2-imidazoline-2-yl)propan]dihydroch loride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydra to (VA-057 manufactured by Wako Pure Chemical Industries, Ltd.); persulfates such as potassium persulfate and ammonium persulfate; peroxide initiators such as di(2-ethylhexyl) peroxydicarbonate, di(4-tert-butylcyclohexyl) peroxydicarbonate, di-sec-butyl peroxydicarbonate, tert-butyl peroxyneodecanoate, tert-hexyl peroxypivalate, tert-butyl peroxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butyl peroxyisobutyrate, 1,1-di(tert-hexylperoxy)cyclohexane, tert-butyl hydroperoxide, and hydrogen peroxide; and a redox system initiator including a combination of a peroxide and a reducing agent, such as a combination of a persulfate and sodium hydrogen sulfite or a combination of a peroxide and sodium ascorbate.

The above polymerization initiators may be used alone or in combination of two or more. The total content of the polymerization initiator(s) is preferably from about 0.005 to about 1 part by weight, more preferably from about 0.02 to about 0.5 parts by weight, based on 100 parts by weight of the monomers.

For example, when the modified (meth)acryl-based graft polymer having a weight average molecular weight as stated above is produced using 2,2′-azobisisobutyronitrile as a polymerization initiator, the amount of the polymerization initiator is preferably from about 0.06 to about 0.2 parts by weight, more preferably from about 0.08 to about 0.175 parts by weight, based on 100 parts by weight of all monomers.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. The chain transfer agents may be used alone or in combination of two or more. The total content of the chain transfer agent(s) should be about 0.1 parts by weight or less, based on 100 parts by weight of all monomers.

Examples of the emulsifier for use in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone or in combination of two or more.

The emulsifier may be a reactive emulsifier. Examples of such an emulsifier having an introduced radically-polymerizable functional group, such as a propenyl group or an allyl ether group, include AQUALON HS-10, HS-20, KH-10, BC-05, BC-10, and BC-20 (all manufactured by DAI-ICHI KOGYO SEIYAKU CO., LTD.) and ADEKA REASOAP SE10N (manufactured by ADEKA CORPORATION). The reactive emulsifier is preferred, because after polymerization, it can improve water resistance by being incorporated in the polymer chain. Based on 100 parts by weight of all monomers, the emulsifier is preferably used in an amount of 0.3 to 5 parts by weight, more preferably 0.5 to 1 part by weight, in view of polymerization stability or mechanical stability.

The glass transition temperature (Tg) of the backbone polymer is 250 K or lower, preferably 240 K or lower. The glass transition temperature is also preferably 200 K or higher. When the glass transition temperature is 250 K or lower, the adhesive composition is good in heat resistance and excellent in internal cohesive strength. This backbone polymer can be prepared by changing monomer components to be used, and the composition ratio therebetween appropriately. Such a glass transition temperature can be attained by using, for example, in solution polymerization, 0.06 to 0.2 parts of a polymerization initiator such as azobisisobutyronitrile or benzoyl peroxide, and a polymerization solvent such as ethyl acetate to cause the monomer components to react with each other at 50 to 70° C. under nitrogen gas flow for 8 to 30 hours. The glass transition temperature (Tg) is gained by calculation in accordance with the following Fox's equation:

1/Tg=W1/Tg1+W2/Tg2+W3/Tg3+ . . . .

In the equation, Tg1, Tg2, Tg3 and the like each represent the respective glass transition temperatures of homopolymers 1, 2, 3 and the like made from the copolymerizable components, respectively, the temperature being represented in the unit of absolute temperature, and W1, W2, W3 and the like each represent the respective weight fractions of the copolymerizable components. The glass transition temperatures (Tg) of the homopolymers are gained from Polymer Handbook (4th edition, John Wiley & Sons, Inc.).

Next, the thus obtained backbone polymer is supplied, as it is or in the form of a solution in which the polymer is diluted with a diluent, for graft polymerization.

The diluent is not particularly limited, and is, for example, ethyl acetate or toluene.

The graft polymerization is conducted by causing a cyclic-ether-group-containing monomer, or a cyclic-ether-group-containing monomer and any other optional monomer to react with the backbone polymer, which is preferably obtained by copolymerizing an alkyl(meth)acryl-based monomer with the acyclic-ether-group-containing monomer and some other monomers.

The cyclic-ether-group-containing monomer is not particularly limited, and is preferably an epoxy-group-containing monomer, an oxetane-group-containing monomer, or a combination of the two.

Examples of the epoxy-group-containing monomer include glycidyl acrylate, glycidyl methacrylate, 3,4-epoxycyclohexylmethyl acrylate, 3,4-epoxycyclohexylmethyl methacrylate, and 4-hydroxybutyl acrylate glycidyl ether. These may be used alone or in combination.

Examples of the oxetane-group-containing monomer include 3-oxetanylmethyl(meth)acrylate, 3-methyl-3-oxetanylmethyl(meth)acrylate, 3-ethyl-3-oxetanylmethyl(meth)acrylate, 3-butyl-3-oxetanylmethyl(meth)acrylate, and 3-hexyl-3-oxetanylmethyl(meth)acrylate. These may be used alone or in combination.

The proportion of the cyclic-ether-group-containing monomer is preferably from 2 to 40% by weight of the entire monomers, more preferably from 4 to 35% by weight thereof.

In the graft polymerization, together with the cyclic-ether-group-containing monomer, a different monomer that can be co-grafted is usable. The monomer is not particularly limited as far as the monomer is a monomer that does not contain cyclic ether group. The monomer is, for example, an alkyl(meth)acrylate having 1 to 9 carbon atoms. Specific examples of the alkyl(meth)acrylate include methyl(meth)acrylate, ethyl(meth)acrylate, n-butyl(meth)acrylate, and 2-ethylhexyl acrylate. Alicyclic(meth)acrylates are also used, examples thereof including cyclohexyl(meth)acrylate, and isobornyl(meth)acrylate. These may be used alone or in combination.

When such a different monomer, which can be co-grafted, is used in the graft polymerization, the radiation quantity of light radiated for curing the adhesive can be lowered. It is presumed that this is because the moving performance of the graft chains is raised, or compatibility between the graft chains or secondarily produced non-grafted chains, and the backbone polymer improves.

It is also preferred that such a different monomer is selected from monomers that are identical with the components of the main chain (trunk) polymer.

As to the amount of the monomer(s) different from the cyclic-ether-group-containing monomer, the ratio by weight of the cyclic-ether-group-containing monomer to the different monomer(s) is preferably from 90:10 to 10:90, more preferably from 80:20 to 20:80 when the monomer(s) is/are blended. If the amount of the different monomer(s) is small, the adhesive may not have a sufficient effect of lowering the radiation quantity of light for being cured. If the amount is large, the adhesive may unfavorably increase in peeling-off resistance after irradiated with light.

Conditions for the graft polymerization are not particularly limited. Thus, the graft polymerization may be conducted by a method known in those skilled in the art. It is preferred in the polymerization to use a peroxide as a polymerization initiator.

The amount of the polymerization initiator is from 0.02 to 5 parts by weight for 100 parts by weight of the backbone polymer. If the amount of the polymerization initiator is small, too much time is unfavorably required for the graft polymerization reaction. If the amount is large, a homopolymer made from the cyclic-ether-group-containing monomer is unfavorably produced in a large proportion.

When the graft polymerization is, for example, solution polymerization, the polymerization can be conducted by adding, to a solution of the acryl-based copolymer, the cyclic-ether-group-containing monomer and a solvent capable of adjusting the viscosity thereof, purging the reaction system with nitrogen, adding thereto 0.02 to 5 parts by weight of a peroxide-type polymerization initiator such as dibenzoyl peroxide, and then heating the system at 50 to 80° C. for 4 to 15 hours. However, the method of the polymerization is not limited to this method.

The states (such as the molecular weight, the size of the graft polymer branch region, and other factors) of the resultant graft polymer can be appropriately selected in accordance with the reaction conditions. The modified (meth)acryl-based graft polymer can also be yielded, for example, by graft-polymerizing 2 to 50 parts by weight of the cyclic-ether-group-containing monomer to 100 parts by weight of the backbone polymer in the presence of 0.02 to 5 parts by weight of a peroxide.

The adhesive composition of the invention for optical applications contains 100 parts by weight of the thus obtained modified (meth)acryl-based graft polymer, and 0.01 to 1.80 parts by weight of an isocyanate crosslinking agent. The isocyanate crosslinking agent is, for example, an isocyanate crosslinking agent as a compound having, in a single molecule thereof, two or more isocyanate groups (the groups may each be an isocyanate-regenerating type functional group, which is an isocyanate group temporarily protected with a blocking agent, a group produced by multimerizing several isocyanate groups, or the like).

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane/tolylene diisocyanate trimer adduct (CORONATE L (trade name) manufactured by NIPPON POLYURETHANE INDUSTRY CO., LTD.), a trimethylolpropane/hexamethylene diisocyanate trimer adduct (CORONATE HL (trade name) manufactured by NIPPON POLYURETHANE INDUSTRY CO., LTD.), and an isocyanurate of hexamethylene diisocyanate (CORONATE HX (trade name) manufactured by NIPPON POLYURETHANE INDUSTRY CO., LTD.); polyether polyisocyanate and polyester polyisocyanate; adducts thereof with various polyols; and polyisocyanates polyfunctionalized with an isocyanurate bond, a biuret bond, an allophanate bond, or the like. In particular, aliphatic isocyanates are preferably used because of their high reaction speed.

About the isocyanate crosslinking agent, one species thereof may be used alone, or two or more species thereof may be used in a mixture form. The content of the whole of the species is preferably from 0.01 to 1.80 parts by weight, more preferably from 0.02 to 1.50 parts by weight, even more preferably from 0.05 to 1.20 parts by weight for 100 parts by weight of the modified (meth)acryl-based graft polymer. The crosslinking agent may be appropriately incorporated, considering the cohesive strength, the inhibition of the peeling off in an endurance test, and others.

It is preferred that the adhesive composition of the invention for optical applications further contains a cationic photopolymerization initiator or thermosetting catalyst in an amount of 0.05 to 10 parts by weight for 100 parts by weight of the modified (meth)acryl-based graft polymer.

As the cationic photopolymerization initiator, any cationic photopolymerization initiator known by those skilled in the art is preferably usable. More specifically, one or more polymerization initiators may be used which are selected from the group consisting of arylsulfonium hexafluorophosphate salts, triarylsulfonium salts, sulfonium hexafluorophosphate salts, and bis(alkylphenyl)iodonium hexafluorophosphate salts.

Such cationic photopolymerization initiators may be used alone or in the form of a mixture of two or more thereof. The content of the whole of the initiators (s) is from 0.1 to 10 parts by weight, preferably from 0.2 to 5 parts by weight for 100 parts by weight of the modified (meth)acryl-based graft polymer.

As the thermosetting catalyst, more specifically, one or more selected from the following group are usable: the group consisting of imidazole compounds, acid anhydrides, phenolic resins, Lewis acid complexes, amino resins, polyamines, and melamine resin. Of these examples, imidazole compounds are particularly preferred. The imidazole compounds are not limited. Examples thereof include 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, and 1-cyanoethyl-2-phenylimidazolium trimellitate. A selection from these compounds is made, considering the curing starting temperature thereof, the compatibility thereof with the adhesive, and others.

The imidazole compounds, out of these examples, are preferably used, for example, because it is sufficient that the addition amount thereof is small. Examples of the imidazole compounds include 2-methylimidazole, 2-heptadecylimidazole, 1,2-dimethylimidazole, 2-phenylimidazole, 2-phenyl-4-methylimidazole, and 1-benzyl-2-methylimidazole.

When the adhesive polymer is, for example, an emulsion in which the polymer is dispersed in water, 1,2-dimethylimidazole is selected. When the adhesive composition gives priority to storability thereof or aims to be thermally cured at a relatively high temperature, 1-cyanoethyl-2-undecylimidazole is selected. When the adhesive composition aims to be cured at a relatively low temperature, 2-phenylimidazole may be selected.

Such thermosetting catalysts for cyclic ether groups may be used alone or in the form of a mixture of two or more thereof. The content of the whole of the catalyst(s) is from 0.05 to 10 parts by weight, preferably from 0.1 to 5 parts by weight for 100 parts by weight of the graft polymer.

It is also preferred that a silane coupling agent is further incorporated into the adhesive composition of the invention for optical applications. The silane coupling agent contains a silane compound having a functional group. Examples of the silane compound include epoxy-group-containing silane coupling agents such as 3-glycidoxypropyltrimethoxysilane, 3-glycidoxypropylmethyldiethoxysilane, and 2-(3,4-epoxycyclohexyl)ethyltrimethoxysilane; amino-group-containing silane coupling agents such as 3-aminopropyltrimethoxysilane, N-2-(aminoethyl)-3-aminopropylmethyldimethoxysilane, 3-triethoxysilyl-N-(1,3-dimethyl-butylidene)propylamine, and N-phenylaminopropyltrimethoxysilane; (meth)acrylic-group-containing silanecoupling agents such as 3-acryloxypropyltrimethoxysilane, and 3-methacryloxypropyltriethoxysialne; and isocyanate-group-containing silane coupling agents such as 3-isocyanatopropyltriethoxysilane.

These silane compounds may be used alone or in the form of a mixture of two or more thereof. The content of the whole of the silane compound(s) is from 0.01 to 5 parts by weight, preferably from 0.05 to 2 parts by weight for 100 parts by weight of the modified (meth)acryl-based graft polymer. When the compound(s) is/are used in this range, the composition favorably has both of adhering strength and re-peeling property.

As a crosslinking agent, an organic crosslinking agent or polyfunctional metal chelate may be together used. The organic crosslinking agent may be an epoxy crosslinking agent (compound having, in a single molecule thereof, two or more epoxy groups). Examples of the epoxy crosslinking agent include ethylene glycol diglycidyl ether, propylene glycol diglycidyl ether, diglycidyl terephthalate acrylate, and spiroglycol diglycidyl ether. These may be used alone or in combination of two or more thereof.

The polyfunctional metal chelate is a substance in which a polyvalent metal is bonded to an organic compound through a covalent bond or coordinate bond. Examples of the polyvalent metal atom include Al, Cr, Zr, Co, Cu, Fe, Ni, V, Zn, In, Ca, Mg, Mn, Y, Ce, Sr, Ba, Mo, La, Sn and Ti. The atom in the organic compound to which the metal is bonded through the covalent bond or coordinate bond may be, for example, an oxygen atom. Examples of the organic compound include alkyl esters, alcohol compounds, carboxylic acid compounds, ether compounds, and ketone compounds.

An oxazoline crosslinking agent or a peroxide may be further incorporated, as a crosslinking agent, in the invention.

The oxazoline crosslinking agent may be any compound, onto which an especial limitation is not imposed, as far as the compound has, in the molecule thereof, an oxazoline group. The oxazoline group may be any one of 2-oxazoline, 3-oxazoline, and 4-oxazoline groups. The oxazoline crosslinking agent is preferably a polymer obtained by copolymerizing an unsaturated monomer with an addition-polymerizable oxazoline, in particular preferably a polymer in which 2-isopropenyl-2-oxazoline is used as the addition-polymerizable oxazoline. An example thereof is “EPOCROS WS-500 (trade name)” manufactured by Nippon Shokubai Co., Ltd.

As the peroxide, an appropriate peroxide is usable which is heated to generate a radical active species for advancing the crosslinkage of the base polymer of the adhesive composition. The peroxide is preferably a peroxide having a one-minute half-life temperature of 80 to 160° C., considering the workability and stability thereof. A peroxide having a one-minute half-life temperature of 90 to 140° C. is more preferably used.

Usable examples of the peroxide include di(2-ethylhexyl) peroxydicarbonate (one-minute half-life temperature: 90.6° C.), di(4-t-butylcyclohexyl) peroxydicarbonate (one-minute half-life temperature: 92.1° C.), di-sec-butyl peroxydicarbonate (one-minute half-life temperature: 92.4° C.), t-butyl peroxy neodecanoate (one-minute half-life temperature: 103.5° C.), t-hexyl peroxypivalate(one-minute half-life temperature: 109.1° C.), t-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutyl peroxy-2-ethylhexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), t-butyl peroxyisobutyrate (one-minute half-life temperature: 136.1° C.), and 1,1-di(t-hexylperoxy)cyclohexane (one-minute half-life temperature: 149.2° C.). Of these examples, preferred are di(4-t-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), and others since these are particularly good in crosslinking reaction efficiency.

The half life of any peroxide is an index for representing the decomposition speed of the peroxide, and denotes a period up to a time when the peroxide is reduced by half in remaining quantity. The decomposition temperature at which the half life is obtained in an arbitrarily selected period, or the time of the half life at an arbitrarily selected temperature is described in a manufacturer's catalog and others, and is described in, for example, “Organic Peroxide Catalogue 9th edition (May 2003)” published by NOF Corporation.

The peroxides may be used alone or in the form of a mixture of two or more thereof. The content of the whole of the peroxide(s) is from 0.01 to 2 parts by weight, preferably from 0.04 to 1.5 parts by weight, more preferably from 0.05 to 1 part by weight for 100 parts by weight of the modified (meth)acryl-based graft polymer. An appropriate amount is selected within this range to adjust the processability, the reworkability, the stability of crosslinkage, the peeling property, and others.

As a method for measuring the peroxide decomposition amount remaining after the reaction treatment, for example, the measurement can be made by HPLC (high-performance liquid chromatography).

More specifically, a portion of about 0.2 g of the adhesive composition after the reaction treatment is taken out, and the portion is immersed into 10 mL of ethyl acetate. The resultant is shaken with a shaker at 25° C. and 120 rpm for 3 hours, and subjected to extraction, and then the extracted material is allowed to stand still at room temperature for 3 days. Next, thereto is added 10 mL of acetonitrile. The resultant is shaken at 25° C. and 120 rpm for 30 minutes, and filtrated through a membrane filter (0.45 μm). The resultant extract, the volume of which is about 10 μL, is injected into an HPLC, and analyzed. In this way, the amount of the peroxide after the reaction treatment can be determined.

The crosslinking agent is used to form the adhesive layer for optical applications. In order to form the adhesive layer, it is necessary to adjust the addition amount of the whole of the crosslinking agent(s) and further consider effects of the crosslinking treatment temperature and the crosslinking treatment period sufficiently.

The adhesive composition of the invention for optical applications may contain an epoxy resin or oxetane resin in order to be further improved in adhering strength or heat resistance.

Examples of the epoxy resin include bisphenol A type, bisphenol F type, bisphenol S type, brominated bisphenol A type, hydrogenated bisphenol A type, bisphenol AF type, biphenyl type, naphthalene type, fluorene type, phenol novolak type, cresol novolak type, trishydroxyphenylmethane type and tetraphenylolethane type, and other type bifunctional and polyfunctional epoxy resins; and hydantoin type, trisglycidyl isocyanurate type, and other glycidyl amine type epoxy resins. These epoxy resins may be used alone or in combination of two or more thereof.

These epoxy resins may be commercially available epoxy resins, to which the resins are not limited. These commercially available epoxy resins are not particularly limited, and examples thereof include jER 828 and jER 806 manufactured by Japan Epoxy Resins Co., Ltd. as bisphenol type epoxy resins; YX 8000 and YX 8034 manufactured by Japan Epoxy Resins Co., Ltd. and EP 4000 and EP 4005 manufactured by Adeka Corporation as alicyclic epoxy resins; Denacol EX-313, EX-512, EX-614B, and EX-810 manufactured by Nagase ChemteX Corporation as polyglycidyl ethers of polyalcohol; and other known epoxy resins.

The oxetane resin may be a known oxetane resin, examples of which include 1,4-bis{[(3-ethyl-3-oxetanyl)methoxy]methyl}benzene, any other xylylenedioxetane, 3-ethyl-3-{[(3-ethyloxetane-3-yl)methoxy]methyl}oxetane, 3-ethylhexyloxetane, 3-ethyl-3-hydroxyoxetane, and 3-ethyl-3-hydroxymethyloxetane. These oxetane resins may be used alone or in combination of two or more thereof.

The oxetane resin may be a commercially available resin, to which the resin is not limited. The commercially available oxetane resin is not particularly limited. Examples thereof include ARON OXETANEs OXT-121, OXT 221, OXT 101, and OXT 212 manufactured by Toagosei Co., Ltd.

As to such an epoxy resin and oxetane resin, either one or a combination of the two is usable in the adhesive composition of the invention for optical applications.

When the epoxy resin and/or the oxetane resin is/are contained in the composition, the total amount thereof is preferably 5 parts or more by weight, more preferably 10 parts or more by weight based on 100 parts by weight of the modified (meth)acryl-based graft polymer, and is preferably 100 parts or less by weight, more preferably 70 parts or less by weight therefor. When the total amount is 5 parts or more by weight, a remarkable effect is recognized for improving the composition in adhering strength and heat resistance. If the total amount is more than 100 parts by weight, the composition may not be sufficiently cured.

When the epoxy resin is added to the composition of the invention, the prepared composition can be a composition that can form an excellent adhesive layer which does not undergo sticking-out of the adhesive or other inconveniences before curing. It can be considered that this is because the grafted cyclic ether group can be made compatible with the low-molecular-weight epoxy resin to form a strong adhesive layer structure.

One or more tackifiers may be further incorporated into the adhesive composition of the present invention. The tackifier(s) may be used in a total amount of 10 to 100 parts by weight, preferably 20 to 80 parts by weight for 100 parts by weight of the modified (meth)acryl-based graft polymer.

Examples of the tackifier(s) include terpene resins manufactured by Yasuhara Chemical Co., Ltd. It is considered that, by dissolving such a resin into ethyl acetate and then blending the solution into the adhesive, the resultant can improve the adhesion at the interface so as to improve the adhering strength.

The adhesive composition of the invention may contain other known additives. For example, one or more of the following can be appropriately added in accordance with an article in which the composition is used: a powder of a colorant, a pigment or the like, a dye, a surfactant, a plasticizer, an adherability supplier, a surface lubricant, a leveling agent, a softener, an antioxidant, an anti-ageing agent, a light stabilizer, an ultraviolet absorbent, a polymerization inhibitor, an inorganic or organic filler, a metallic powder, a particulate substance, a foil-piece-form substance and others. A redox system obtained by the addition of a reducing agent may be adopted as far as the system can be controlled.

The adhesive layer of the invention for optical applications is formed, from the thus obtained adhesive composition for optical applications, preferably onto at least one side of a support.

The adhesive layer for optical applications can be formed by applying the adhesive composition onto a single surface or both surfaces of a supporting substrate, and then drying the workpiece although the method for the formation is not limited to this method. The adhesive layer or the adhesive layer can also be formed by, for example, a method of transferring one or more adhesive layers formed on a separator (releasing film) onto a single surface or both surfaces of a supporting substrate. It is allowable to use a separator as the supporting substrate, thereby utilizing the adhesive layer as, for example, a double sided adhesive layer without having any substrate when the layer is practically used. The adhesive layer or an analogue thereto is used in, for example, a sheet or tape form.

The method for forming the adhesive layer is more specifically, for example, a method of painting the adhesive composition onto, for example, a releasing-treated separator, drying/removing the polymerization solvent and others therein to conduct crosslinking treatment, thereby forming the adhesive layer, and then transferring this layer onto a support such as an optical member, or a method of painting the adhesive composition onto an optical member, and drying/removing the polymerization solvent and others therein to conduct optical crosslinking treatment, thereby forming the adhesive layer onto the optical member. In the painting of the adhesive, newly, one or more solvents other than the polymerization solvent may be appropriately added.

The releasing-treated separator is preferably a silicone release liner. In the step of painting the adhesive composition of the invention onto such a liner, and drying the workpiece to form an adhesive layer, the method for drying the adhesive may be a proper method adoptable appropriately in accordance with a purpose. The method is preferably a method of heating and drying a film based on the painting. The temperature for the heating and drying is preferably from 40 to 200° C., more preferably from 50 to 180° C., in particular preferably from 70 to 170° C. When the heating temperature is set within the range, an adhesive having excellent adhesive properties can be obtained.

The drying period may be a proper period adoptable appropriately. The drying period is preferably from 5 seconds to 20 minutes, more preferably from 5 seconds to 10 minutes, in particular preferably from 10 seconds to 5 minutes.

After an anchor layer is formed on a surface of a support, or an easily-bonding treatment that may be of various types, such as corona treatment or plasma treatment, is applied thereonto, the adhesive layer can be formed thereonto. The easily-bonding treatment may be applied onto the front surface of the adhesive layer.

The method for forming the adhesive layer may be a method that may be of various types. Specific examples thereof include roll coating, kiss-roll coating, gravure coating, reverse coating, roll brushing, spray coating, dip roll coating, bar coating, knife coating, air knife coating, curtain coating, lip coating, and an extrusion coating method using, for example, a die coater.

The thickness of the adhesive layer is not particularly limited, and is, for example, from about 1 to 400 μm. The thickness is preferably from 2 to 200 μm, more preferably from 2 to 150 μm.

When the adhesive layer is naked, the adhesive layer may be protected by a sheet (separator) subjected to releasing treatment until the layer is put into practical use.

Examples of the constituting material of such a protective separator include plastic films such as polyethylene, polypropylene, polyethylene terephthalate and polyester films, porous materials such as paper, cloth and nonwoven cloth, and appropriate sheet-form pieces such as a net, a foamed sheet, a metal foil piece, and a laminated body made of two or more of these members. A plastic film is preferably usable since the film is excellent in surface smoothness.

The plastic film is not particularly limited as far as the film is a film capable of protecting the adhesive layer. Examples thereof include polyethylene, polypropylene, polybutene, polybutadiene, polymethylpentene, polyvinyl chloride, vinyl chloride copolymer, polyethylene terephthalate, polybutylene terephthalate, polyurethane, and ethylene-vinyl acetate copolymer films.

The thickness of the separator is usually from about 5 to 200 μm, preferably from about 5 to 100 μm. The separator may be optionally subjected to releasing and anti-fouling treatments with a releasing agent of a silicone, fluorine, long-alkyl-chain or aliphatic-acid-amide type, silica powder or some other, or to an antistatic treatment of, e.g., a painting, kneading, or vapor-deposition type. The separator can be further heightened in peeling property or releasability from the adhesive layer, in particular, by subjecting the surface of the separator appropriately to a releasing treatment such as silicone treatment, long-alkyl-chain treatment, or fluorine-treatment.

The releasing-treated sheet is usable, as it is, as a separator of an adhesive sheet, so that the process (concerned) can be made simple.

The support, such as the optical member, may be a support usable for forming an image display device such as a liquid crystal display device. The kind thereof is not particularly limited. The optical film is preferably an optical film having a drawn film such as a polarizing plate or a retardation plate. The optical film may also be a light diffusion film, a brightness enhancement film, or some other.

As the polarizing plate, a polarizing plate is generally used in which a polarizer has, on a single surface or both surfaces thereof, one or more protective layers, in particular preferably one or more transparent protective films. The polarizer is not particularly limited, and may be of various types. The polarizer is, for example, a polarizer obtained by adsorbing a dichroic substance such as iodine or a dichroic dye into a hydrophilic polymer film, such as a polyvinyl alcohol film, a partially formalized polyvinyl alcohol film or an ethylene/vinyl acetate copolymer based partially saponified film, and then drawing the film uniaxially, or a polyene-aligned film made of, for example, a polyvinyl-alcohol dehydrated product or a polyvinyl-chloride dehydrochloride-treated product. Of such films, preferred is a polarizer composed of a polyvinyl alcohol film and a dichroic substance such as iodine. The thickness of such a polarizer is not particularly limited, and is generally from about 5 to 80 μm.

The material that forms the transparent protective film(s) laid on a single surface or both surfaces of the polarizer is preferably a material excellent in transparency, mechanical strength, thermal stability, water blocking performance, isotropy and others. Examples thereof include polyester polymers such as polyethylene terephthalate, and polyethylene naphthalate; cellulose polymers such as diacetylcellulose, and triacetylcellulose; acryl-based polymers such as polymethyl methacrylate; styrene polymers such as polystyrene, and acrylonitrile/styrene copolymer (AS resin); and polycarbonate polymers. Other examples of the polymer that forms the transparent protective film(s) include polyolefin polymers such as polyethylene, polypropylene, cyclic polyolefins, polyolefins each having a norbornene structure, and ethylene/propylene copolymer; vinyl chloride polymers; amide polymers such as nylon, and aromatic polyamides; imide polymers; sulfone polymers; polyethersulfone polymers; polyetheretherketone polymers; polyphenylene sulfide polymers; vinyl alcohol polymers; vinylidene chloride polymers; vinyl butyral polymers; arylate polymers; polyoxymethylene polymers; epoxy polymers; and blended products made of two or more of these polymers. The transparent protective film(s) may (each) be formed as a cured layer of a thermosetting or ultraviolet-ray curing-type resin of an acrylic, urethane, acrylurethane, epoxy or silicone type, or some other type.

The transparent protective film(s) may (each) be a polymer film described in JP-A-2001-343529 (WO 01/37007), for example, a resin composition containing (A) a thermoplastic resin having, at its side chain, a substituted and/or unsubstitutedimide group, and (B) a thermoplastic resin having, at its side chain, a substituted and/or unsubstituted phenyl group and a nitrile group. A specific example thereof is a film made of a resin composition containing an alternate copolymer made from isobutylene and N-methylmaleimide, and acrylonitrile/styrene copolymer. The film may be a film that is, for example, an extruded mixed product of the resin composition.

The thickness of the protective film(s) may be appropriately decided, and is generally from about 1 to 500 μm from the viewpoint of the strength, the handleability and other workabilities, the thin layer property of the film, and others. The thickness is in particular preferably from 5 to 200 μm.

The optical film may be an optical layer that may be used for a liquid crystal display device or the like. Examples of the layer include reflectors, anti-transmissive plates, retardation plates, which may be, for example, half and quarter wavelength plates, viewing angle compensation films, and brightness enhancement films. These may be used alone as an optical film, or may be used in a form that one or more thereof are laminated onto each other on the polarizing plate when practically used. It is also preferred that one or more of these layers are laminated, in particular, on a polarizing plate having on a single surface thereof a protective layer and at the surface of the polarizing plate that is opposite to the protective-layer-formed surface thereof.

The optical film is in particular preferably a reflective type polarizing plate or semi-transmissive type polarizing plate in which a reflector or a semi-transmissive reflector is further laminated on a polarizing plate; an elliptically polarizing plate or circularly polarizing plate in which a retardation plate is further laminated on a polarizing plate; a wide viewing angle polarizing plate in which a view angle compensation film is further laminated on a polarizing plate; or a polarizing plate in which a brightness enhancement film is further laminated on a polarizing plate component.

Such a polarizing plate, in which a polarizing plate component and a brightness enhancement film are bonded to each other, is usually used in the state of being laid on the rear side of a liquid crystal cell. The brightness enhancement film is a film exhibiting a property that when natural light is radiated into the film, for example, from a backlight of a liquid crystal display device or some other device, or by reflection on the rear side of the device, the film reflects a linearly polarized light ray having a predetermined polarization axis or a circular polarized light ray along a predetermined direction, and the film transmits the other light rays. When light is radiated from the backlight or some other light source into the polarizing plate, in which the brightness enhancement film is laminated on the polarizing plate component, this polarizing plate gains a transmitted light ray in a predetermined polarized state, and further reflects the light rays other than the predetermined-polarized-state light ray without transmitting the light rays. The brightness enhancement film is a film that can improve brightness by the following: the light reflected on the brightness enhancement film surface is reversely directed through a reflecting layer or the like that is laid in the rear of the brightness enhancement film, thereby radiating the light again into the film; the film transmits a part or the whole of the radiated-into light as light in a predetermined polarized state, thereby increasing the quantity of the light transmitted into the film; and further the film supplies a polarized light ray that the polarizer (concerned) does not easily absorb to the liquid crystal display device or the other device, so that light quantity usable in the device is increased. In other words, when the backlight or the other light source is used to radiate light from the rear side of the liquid crystal cell (concerned) into the cell through the polarizer without using any brightness enhancement film, the polarizer absorbs almost all of light rays each having a polarization direction not consistent with the polarization axis of the polarizer. Thus, the polarizer does not transmit these light rays. Specifically, the polarizer absorbs about 50% of the light, which is varied in accordance with properties of the used polarizer. The light quantity usable in the liquid crystal display device or the other device is decreased accordingly. Thus, its image becomes dark. The brightness enhancement film causes light rays each having a polarization direction as absorbed by the polarizer not to be radiated into the polarizer, and reflects the rays once. Furthermore, the light rays are reversely directed through the reflecting layer or the like that is laid in the rear of the film, and then radiated into the brightness enhancement film again. This is repeated. The brightness enhancement film transmits only polarized light rays which are reflected and reversely directed between the two and which come to have a polarization direction that is transmissible in the polarizer, and then supplies these rays to the polarizer. Thus, the brightness enhancement film makes it possible to use light from the backlight or the other light source effectively for displaying an image on the liquid crystal display device, and further brighten its screen.

A diffusion plate may be laid between the brightness enhancement film and the reflecting layer or the like. Polarized-state light reflected on the brightness enhancement film is directed to the reflecting layer or the like. The laid diffusion plate evenly diffuses the light transmitted therein and simultaneously cancels the polarized state so that the light turns into a non-polarized state. Specifically, the natural light state light is directed to the reflecting layer or the like, reflected on the reflecting layer or the like, and again transmitted in the diffusion plate to be again radiated into the brightness enhancement film. This is repeated. When the diffusion plate for returning polarized light into original natural light is laid in this way between the brightness enhancement film and the reflecting layer or the like, the display screen can maintain brightness and simultaneously this display screen can be reduced in brightness unevenness. Thus, this screen can be made bright and even. It can be considered that: when the diffusion plate is laid, the number of repetitive times of the reflection of the initially radiated-into light is appropriately increased; and the increase together with the diffusion function of the diffusion plate makes it possible to make the display screen bright and even.

The brightness enhancement film may be an appropriate brightness enhancement film, for example, a film showing a property of transmitting a linearly polarized light ray having a predetermined polarization axis and reflecting the other light rays, such as a multilayered film composed of dielectric substances, or a multilayer laminated product composed of thin films different from each other in refractive index anisotropy; or a film showing a property of reflecting either a clockwise or counterclockwise circular polarized light ray and transmitting the other light rays, such as an aligned film made of a cholesteric liquid crystal polymer, or a member in which an aligned liquid crystal layer made of the same polymer is supported on a film substrate.

Thus, with the brightness enhancement film of the above-mentioned type of transmitting a linearly polarized light ray having a predetermined polarization axis, by radiating the transmitted light ray, as it is, into a polarizing plate in the state of making their polarization axes consistent with each other, the light ray can be efficiently transmitted through the polarizing plate while an absorption loss based on the polarizing plate is restrained. About the brightness enhancement film of the type of transmitting a circular polarized light ray, such as a cholesteric liquid crystal layer, the transmitted light ray can be radiated, as it is, into a polarizer. It is however preferred for restraining absorption loss to convert the circular polarized light ray to a linearly polarized light ray through a retardation plate, and then radiate the light ray into a polarizing plate. By using, as the retardation plate, a quarter wavelength plate, a circular polarized light ray can be converted to a linearly polarized light ray.

A retardation plate functioning as a quarter wavelength plate in a wide wavelength range, such as the visible ray range, can be obtained in the manner of putting a retardation plate functioning as a quarter wavelength plate for, for example, a thin-color light ray having a wavelength of 550 nm onto a retardation layer showing some other retardation property, for example, a retardation layer functioning as a half wavelength plate, or in some other manner. Thus, the retardation plate to be arranged between the polarizing plate and the brightness enhancement film may be a retardation plate made of one or more retardation layers.

About a cholesteric liquid crystal layer also, this layer can be rendered a layer reflecting a circular polarized light ray in a wide wavelength range, such as the visible ray range, by making the layer into a layout structure in which two or more layers different from each other in reflection wavelength are combined with each other. On the basis of this, transmitted circular polarized light having a wide wavelength range can be obtained.

The polarizing plate may be the above-mentioned polarized light separating type polarizing plate, or any other polarizing plate in which two or more optical layers are laminated onto a polarizing plate component. Thus, the polarizing plate may be, for example, a reflective type elliptically polarizing plate or semi-transmissive type elliptically polarizing plate in which the above-mentioned reflective type polarizing plate or semi-transmissive type polarizing plate is combined with a retardation plate.

An optical film in which optical layers as described above are laminated on a polarizing plate component can be formed by a method of laminating the optical layers successively and individually in a process for producing a liquid crystal display device or some other device. The optical film which is an optical film obtained by laminating the optical layers beforehand is excellent in quality stability, fabricating workability and others to produce an advantage of improving the process for producing the liquid crystal display device or the other device. For the laminating, an appropriate bonding means, such as an adhesive layer, may be used. When the polarizing plate component is bonded to the other optical layers, their optical axes may be set to have an appropriate layout angle in accordance with, for example, a target retardation property.

The adhesive attached optical film of the invention is favorably usable for, for example, the formation of an image display device that may be of various types, such as a liquid crystal display device. The formation of the liquid crystal display device can be attained in accordance with a conventional method. Specifically, in general, a liquid crystal display device is formed, for example, by fabricating appropriately a liquid crystal cell, an adhesive attached optical film, an optional lighting system and other constituent members, and then integrating a driving circuit into the workpiece; in the invention, the formation of the liquid crystal display device is according to such a conventional method, and is not particularly limited except that the optical film according to the invention is used. Its liquid crystal cell may be a cell of any type, such as a TN, STN, or n type.

An appropriate liquid crystal display device can be formed, examples of which include a liquid crystal display device in which the adhesive attached optical film is arranged on one or each of the two sides of a liquid crystal cell, and a liquid crystal display device in which a backlight or a reflector is used as a lighting system. In this case, one or two optical films according to the invention may be located at one or both of the sides of the liquid crystal cell. When the optical films are located at both the sides, respectively, the films may be the same or different. When the liquid crystal display device is formed, one or more appropriate members selected from the following may be arranged in the form of one or more layers at one or more appropriate positions: a diffusion plate, an anti-glare layer, an anti-reflection film, a protective plate, a prism array, a lens array sheet, a light diffusion plate, a backlight, and others.

The following will describe an organic electroluminescence device (organic EL display device). The optical film (such as the polarizing plate) of the invention can also be used in an organic EL display device. Generally, in an organic EL display device, a transparent electrode, an organic luminous layer and a metal electrode are successively laminated onto a transparent substrate to forma luminous body (organic electroluminescence body). The organic luminous layer is a laminated body composed of various organic thin films. As the structure of this layer, a structure having a combination that may be of various types is known. Examples of the structure include a laminated body composed of a hole injection layer made of, for example, a triphenylamine derivative, and a luminous layer made of a fluorescent organic solid such as anthracene; a laminated body composed of such a luminous layer and an electron injection layer made of, for example, a perylene derivative; and a laminated body composed of the same hole injection layer, luminous layer and electron injection layer.

In an organic EL display device, by applying a voltage to its transparent electrode and its metal electrode therebetween, holes and electrons are injected to its organic luminous layer, and the holes and electrons are recombined to generate energy. The energy excites the fluorescent substance. When the excited fluorescent substance is returned to a ground state thereof, light is radiated. By this principle, light is emitted. The mechanism of the recombination in the middle of this process is equivalent to that of ordinary diodes. As can be expected from this matter, the electric current and the luminescence intensity show an intense non-linearity, with rectification, relative to the applied voltage.

In an organic EL display device, at least one of its electrodes needs to be transparent to take out luminescence from its organic luminous layer. Usually, as a positive electrode of the electrodes, a transparent electrode made of a transparent conductor such as indium tin oxide (ITO) is used. In order to make the injection of electrons easy to raise the luminescence efficiency, it is important to use a substance small in work function as a negative electrode of the electrodes. Usually, an electrode made of a metal, such as Mg—Ag or Al—Li, is used.

In an organic EL display device having such a structure, its organic luminous layer is a very thin film having a thickness of about 10 nm. Thus, equivalently to its transparent electrode, the organic luminous layer transmits light substantially completely. As a result, when no light is emitted, light radiated into the device from the outer surface of its transparent substrate, transmitted through the transparent electrode and the organic luminous layer and then reflected on its metal electrode is again directed to the outer surface of the transparent substrate. Accordingly, when the organic EL display device is viewed from the outside, the display surface of the device looks like a mirror plane.

In an organic-electroluminescent-body-containing organic EL display device having a transparent electrode on the front surface side of its organic luminous layer, which emits light when a voltage is applied to the device, and further having a metal electrode on the rear surface side of the organic luminous layer, a polarizing plate may be located on the front surface side of the transparent electrode and further a retardation plate may be interposed between the transparent electrode and the polarizing plate.

Since the retardation plate and the polarizing plate have an action of polarizing light radiated thereinto from the outside and then reflected on the metal electrode, these members have an effect that the mirror plane of the metal electrode is caused not to be viewed from the outside by the polarizing effect. In particular, in the case of rendering the retardation plate a quarter wavelength plate and adjusting the angle between the polarization direction of the polarizing plate and that of the retardation plate to π/4, the mirror plane of the metal electrode can be completely shielded.

In short, about external light radiated into this organic EL display device, only its linearly polarized light component is transmitted by effect of the polarizing plate. This linearly polarized light ray is generally turned to be an elliptically polarized light ray through the retardation plate. However, when the retardation plate is a quarter wavelength plate and further the angle between the polarization direction of the polarizing plate and that of the retardation plate is π/4, the light ray is turned to be a circular polarized light ray.

This circular polarized light ray is transmitted through the transparent substrate, the transparent electrode, and the organic thin film, reflected on the metal electrode and again transmitted through the organic thin film, the transparent electrode and the transparent substrate so as to be again turned to be a linearly polarized light ray through the retardation plate. This linearly polarized light ray is perpendicular to the polarization direction of the polarizing plate so as not to be transmissive through the polarizing plate. As a result, the mirror plane of the metal electrode can be completely shielded.

The adhesive layer of the invention for optical applications is irradiated with a specific light ray, subjected to thermal treatment, or subjected to the two treatments to be cured. Thus, a cured adhesive layer for optical applications can be formed. Before or after the adhesive layer of the invention for optical applications is bonded to an adherend, the layer can easily be cured by irradiation with light or thermal treatment.

The light for the irradiation is not particularly limited, and is preferably ultraviolet rays, visible rays, or an active energy ray such as an electron beam. Crosslinking treatment with the irradiation with ultraviolet rays can be conducted, using an appropriate ultraviolet source, such as a high-pressure mercury lamp, a low-pressure mercury lamp, an excimer laser, or a metal halide lamp. The radiation dose of the ultraviolet rays may be appropriately selected in accordance with a required crosslinkage degree. Usually, it is desired to set the radiation dose of the ultraviolet rays within the range of 0.2 to 10 J/cm². The temperature at the time of the irradiation is not particularly limited, and is preferably up to about 140° C. under consideration of the heat resistance of the support.

When the adhesive composition of the invention for optical applications contains a thermosetting catalyst, the composition is heated to be cured. Thus, by heating the adhesive layer of the invention before the layer is bonded to an adherend, the layer can easily be cured.

In the case of using a thermosetting catalyst for a cyclic ether group low in curing starting temperature, a curing reaction of the cyclic ether group is caused together with the drying of the solvent, and a reaction of the backbone polymer of the adhesive composition in the step of heating and drying the composition. Thus, the pressure-sensitive adhesive sheet of the invention can be prepared without conducting a further heating treatment.

In the case of using a thermosetting catalyst for a cyclic ether group high in curing starting temperature, only the following advances in the drying step: the drying of the solvent, and a reaction of the backbone polymer of the adhesive composition. As a result, the cyclic ether group remains. Thus, the adhesive layer of the invention can be obtained with or without conducting a further heating treatment.

A temperature condition and other conditions for the thermosetting are not particularly limited. The temperature is preferably a temperature up to about 170° C. under consideration of the heat resistance of the support.

After the curing reaction of the cyclic ether group, the gel fraction is from 70 to 98%, preferably from 80 to 98%. When the adhesive layer is an adhesive layer very high in cohesive strength, the storage elastic modulus thereof is from 6×10⁴ to 1.0×10⁷ Pa at 23° C. At 80° C., the storage elastic modulus thereof is from 6×10⁴ to 1.0×10⁷ Pa. When the pressure-sensitive adhesive sheet in which the cyclic ether group is caused to remain is heated after the sheet is bonded to an adherend, thereby advancing a curing reaction of the remaining cyclic ether group, the sheet can exhibit two functions of temporary bonding thereof onto the adherend, and strong bonding thereof to the adherend on the basis of heating.

The gel fraction in the cured adhesive layer of the invention for optical applications is preferably at least 6% higher than that in the adhesive layer before the layer is cured. When the gel fraction is at least 6% higher, a strong bonding is attained by the curing.

The cured adhesive layer of the invention for optical applications has a haze of 2.0 or less, preferably 1.0 or less.

The adhesive layer or the cured adhesive layer of the invention for optical applications can be bonded to various light sources or image display elements. The resultants are excellent not only in tackiness and cohesive strength, but also in long-term durability.

A large advantageous effect can be observed even when the light source used is any one of a PDP phosphor, an LED phosphor, an organic EL, a cold cathode tube, a laser light source, and others. A manner may be used in which the adhesive layer is directly laid onto any one of these sources. Preferably, a glass or plastic substrate of an article into which such a light source is integrated is used, examples of the article including a liquid crystal television having, as its front surface, a glass plate or acrylic plate, a backlight or light-guiding plate of a monitor, a lighting equipment having an LED as a light source, and an organic EL lighting equipment.

### EXAMPLES

Hereinafter, the invention will be specifically described by way of working examples. However, the invention is not limited by these examples. In each of the examples, the word “part(s)” and the symbol “%” are part(s) by weight and % by weight, respectively. Hereinafter, conditions that any member is allowed to stand still at room temperature are conditions that the member is done at 23° C. and 65% RH (for 1 hour or 1 week) unless otherwise specified.

<Measurement of Weight-Average Molecular Weight>

The weight-average molecular weight of any modified (meth)acryl-based graft polymer to be obtained was measured by GPC (gel permeation chromatography). A sample used therefor was a filtrate obtained by dissolving a specimen from the polymer into dimethylformamide to prepare a 0.1% by weight solution thereof, allowing this solution to stand still all night, and filtrating the resultant system through a membrane filter of 0.45 μm mesh.
Analyzer: HLC-8120 GPC, manufactured by Tosoh Corporation
Columns: G7000H_{XL}+GMH_{XL}+GMH_{XL}, manufactured by Tosoh Corporation
Column size: the columns each having a diameter of 7.8 mm and a length of 30 cm; total length: 90 cm
Eluent:tetrahydrofuran (concentration: 0.1% by weight)
Flow rate: 0.8 mL/min.
Detector: differential refractive index detector (RI)
Column temperature: 40° C.
Injected volume: 100 μL
Standard sample: polystyrene

<Gel Fraction Measurement>

Any dried and crosslinked adhesive (initial weight: W1) was immersed in an ethyl acetate solution, and the resultant system was allowed to stand still at room temperature for 1 week. Therefrom, any insoluble content was then taken out, and dried.

The dry weight (W2) thereof was measured. The gel fraction was calculated out in accordance with the following.

Gel fraction=(W2/W1)×100

<Haze>

An pressure-sensitive adhesive sheet sample of 30 mm width obtained in each of Examples and Comparative Examples, which was a sample after irradiated with light, was used, and the haze (%) thereof was measured in accordance with JIS K-7136 at an atmosphere temperature of 25° C. by means of a reflectivity/transmissivity meter, model HR-100, manufactured by Murakami Color Research Laboratory Co., Ltd., using a D-65 light ray.

<Dynamic Viscoelasticity Measuring Method>

Any adhesive layer after irradiated with UV rays was measured for the dynamic viscoelasticity thereof (at 23° C. and 80° C.)

Device: ARES, manufactured by T A Instruments. Japan.

Deformation mode: torsion

Measuring frequency: constant frequency of 1 Hz

Temperature-raising rate: 5° C./min.

Measuring temperatures: measurement at temperatures from a temperature near the glass transition temperature of the adhesive to 160° C.

Shape: parallel-plate-shape having a diameter of 8.0 mm

Sample thickness: 0.5 to 2 mm (at an initially sample-fitted stage)

The storage elastic modulus (G′) was read out at 23° C.

<Contrast Evaluation>

From a commercially available liquid crystal television “40-inch BRAVIA W1”, its liquid crystal panel was taken out, and all of its optical films including a polarizing plate and arranged over and under its liquid crystal cell were taken away. The front and rear surfaces of the glass plate of this liquid crystal cell were cleaned. Thus obtained cell was used as a liquid crystal cell. The adhesive layer side of an adhesive attached polarizing plate 1 obtained in each of Examples and Comparative Examples was bonded onto the viewing side of the liquid crystal cell to make the absorption axis direction of the polarizing plate substantially parallel to the long side direction of the liquid crystal cell. Next, the adhesive layer side of an adhesive attached polarizing plate 2 obtained in each of Examples and Comparative Examples was bonded onto the liquid crystal cell side (backlight side) opposite to the viewing side of the cell to make the absorption axis direction of the polarizing plate substantially orthogonal to the long side direction of the liquid crystal cell. Thus obtained cell was used as a liquid crystal panel. The absorption axis direction of the adhesive attached polarizing plate 1 at the viewing side of the liquid crystal panel was substantially orthogonal to that of the adhesive attached polarizing plate 2 at the backlight side thereof. The liquid crystal panel was unified with the backlight unit of the original liquid crystal display device to produce a liquid crystal display device. About the liquid crystal display device, a measurement was made about the contrast ratio in the front side direction. In the measurement of the contrast ratio, the backlight was turned on at a dark room at 23° C. After 30 minutes elapse from the turning-on time, an instrument “BM-5” manufactured by Topcon Corporation was used to measure the Y value of the display device according to the XYZ system in the state that its lens was arranged at a position 50 cm apart from the front of the panel when each of a white image and a back image was displayed. From the Y value (YW: white brightness) in the while image and the Y value (YB: black brightness) in the black image, the contrast ratio (YW/YB) in the front side direction was calculated out.

<Unevenness (Brightness Ratio) Calculating Method>

About the same device as used for the contrast evaluation, the plane brightness thereof was measured. After 30 minutes elapse from a time when its backlight was turned on, a black image was displayed therein. Through a brightness distribution measuring instrument (“CA-1500”, manufactured by Konica Minolta, Inc.), the “brightness ratio”=“minimum brightness”/“maximum brightness” was calculated out. When the brightness ratio was calculated out through the measuring instrument, the panel was divided into 12 sections of 4 rows×3 files. The smallest brightness generated in the four central sections was defined as the minimum brightness and the largest brightness generated in the whole of the panel plane was defined as the maximum brightness for the present evaluation. In this way, the ratio was calculated out.

<Heating/Humidifying Test>

The adhesive layer side of another adhesive attached polarizing plate 1 was bonded to each of both the sides of a non-alkali glass piece of 40 cm×30 cm size to keep a crossed nicols state. This sample and the same were allowed to stand still in an autoclave having a temperature of 50° C. and a pressure of 0.5 MPa for 15 minutes, and then put in environments of 90° C. and of 60° C. and 90% RH, respectively, for 500 hours. Thereafter, the samples were observed about delamination or foaming therein. When any one of the samples had delamination or foaming, the sample was judged to be bad (x); when it had slight foaming, the sample to be fair (A); and when it had neither delamination nor foaming, the sample to be good (0).

<Production of Polarizing Plates>

(Transparent Protective Films)

Prepared were TAC films (trade name: “80UL”, manufactured by FUJIFILM Corporation) having a thickness of 80 μm. These were used as transparent protective films.

(Polarizers)

Polymer films (trade name: “VF-PS #7500”, manufactured by Kuraray Co., Ltd.) made mainly of a polyvinyl alcohol resin and each having a thickness of 75 μm were each immersed in 5 baths satisfying conditions [1] to [5] described below while tension was given to the film along the longitudinal direction thereof. In this way, the film was drawn to give a final draw ratio of 6.2 relative to the original length of the film. This drawn film was dried inside an air-circulating oven of 40° C. temperature for 1 minute. In this way, each polarizer having a thickness of 28 μm was produced.

### <Conditions>

[1] Swelling bath: pure water of 30° C. temperature.
[2] Dyeing bath: aqueous solution of 30° C. temperature containing 100 parts by weight of water, 0.032 parts by weight of iodine, and 0.2 parts by weight of potassium iodide.
[3] First crosslinking bath: aqueous solution of 40° C. temperature containing 3% by mass of potassium iodide, and 3% by mass of boric acid.
[4] Second crosslinking bath: aqueous solution of 60° C. temperature containing 5% by mass of potassium iodide, and 4% by mass of boric acid.
[5] Water washing bath: aqueous solution of 25° C. temperature containing 3% by mass of potassium iodide.

(Optical Compensation Layer)

A tenter drawing machine was used to draw a norbornene-resin-containing polymer film (trade name: “ARTON”, manufactured by JSR Corporation) having a thickness of 100 μm 2.8 times by a fixed-end transversely uniaxial drawing method (method of drawing any film in the width direction while fixing the film along the longitudinal direction) in an air-circulating thermostat oven of 155° C. temperature, so as to produce an optical compensation layer of 45 μm thickness.

(Production of Polarizing Plate 1)

Two of the above-mentioned transparent protective films were bonded through a water-soluble adhesive (trade name: “GOHSEFIMER Z200”, manufactured by The Nippon Synthetic Chemical Industry Co., Ltd.) containing a polyvinyl alcohol resin onto both the sides of one of the above-mentioned polarizers. In this way, a polarizing plate 1 was produced which had a tri-layered structure of the transparent-protective-film/polarizer/transparent-protective-film.

(Production of Polarizing Plate 2)

The above-mentioned optical compensation layer was bonded through a water-soluble adhesive (trade name: “GOHSEFIMER Z200”, manufactured by The Nippon Synthetic Chemical Industry Co., Ltd.) containing a polyvinyl alcohol resin onto one of both the sides of one of the above-mentioned polarizers to make the slow axis of the optical compensation layer orthogonal to the absorption axis of the polarizer. Next, one of the transparent protective films was bonded through the same water-soluble adhesive onto the other side of the polarizer. In this way, a polarizing plate 2 was produced which had a tri-layered structure of the optical-compensation-layer/polarizer/transparent-protective-film.

### Example 1

### Acryl-Based Polymer Preparation

Into a four-necked flask equipped with stirring vanes, a thermometer, a nitrogen gas introducing tube, and a condenser were charged 85 parts by weight of n-butyl acrylate (BA), 15 parts by weight of methoxyethyl acrylate (MEA), 3 parts by weight of 4-hydroxybutyl acrylate (HBA), and 0.1 parts by weight of 2,2′-azobisisobutyronitrile as a polymerization initiator together with 200 parts by weight of ethyl acetate. While the solution was slowly stirred, nitrogen gas was introduced into the flask to purge the inside with nitrogen over 1 hour. Thereafter, the liquid inside the flask was kept at a temperature of about 55° C. to conduct polymerization reaction for 10 hours to prepare a solution of an acryl-based polymer having a weight-average molecular weight of 900,000. The resultant acryl-based polymer had a glass transition temperature of 233 K.

(Graft Polymer Preparation)

The resultant acryl-based polymer solution was diluted with ethyl acetate to give a solid concentration of 25% to prepare a diluted solution (I). Into a four-necked flask equipped with stirring vanes, a thermometer, a nitrogen gas introducing tube, and a condenser were charged 400 parts by weight of the diluted solution (I), 10 parts by weight of 4-hydroxybutyl acrylate glycidyl ether (4HBAGE), 10 parts by weight of 2-ethylhexyl acrylate, and 0.1 parts by weight of benzoyl peroxide. While the solution was slowly stirred, nitrogen gas was introduced into the flask to purge the inside with nitrogen over 1 hour. Thereafter, the liquid inside the flask was kept at a temperature of about 65° C. for 4 hours and next kept at a temperature of 70° C. for 4 hours to conduct polymerization reaction to yield a graft polymer solution.

(Formation of Adhesive Layer)

Next, into 100 parts by weight of any solid in the thus yielded graft polymer solution were incorporated 0.1 parts by weight of a trimethylolpropane adduct (TAKENATE D110N (NCO) manufactured by Mitsui Chemicals, Inc.) of xylylene diisocyanate, 0.25 parts by weight of arylsulfonium hexafluorophosphate (ESACURE 1064, manufactured by Lamberti) as an optical initiator, and 0.1 parts by weight of 3-glycidoxypropyltrimethoxysilane (KBM 403, manufactured by Shin-Etsu Chemical Co., Ltd.) as a silane coupling agent to prepare an adhesive solution.

This adhesive solution was painted onto one side of a silicone-treated polyethylene terephthalate (PET) film (“MRF-38”, manufactured by Mitsubishi Plastics, Inc.) of 38 μm thickness in such a manner that a layer of the adhesive would give a thickness of 25 wafter dried. This workpiece was dried at 120° C. for 3 minutes to form an adhesive layer. The adhesive layer was bonded onto the transparent protective film of one of the two sides of the polarizing plate 1, and then a metal halide UV lamp was used to irradiate the workpiece with light at 1.5 J/cm² from the adhesive layer side thereof. In this way, an adhesive attached polarizing plate 1 (adhesive layer/transparent protective film/polarizer/transparent protective film) was produced.

Instead of the polarizing plate 1, the polarizing plate 2 was used. The same adhesive layer was bonded onto the optical compensation layer of the polarizing plate 2. A metal halide UV lamp was used to irradiate the workpiece with light at 1.5 J/cm² from the adhesive layer side thereof. In this way, an adhesive attached polarizing plate 2 (adhesive layer/optical compensation layer/polarizer/transparent protective film) was produced.

(Formation of adhesive layer) Gel-fraction measuring sample: 1B The above-mentioned adhesive solution was painted onto a single surface of a silicone-treated PET film (MRF-38, manufactured by Mitsubishi Plastics, Inc.) of 38 μm thickness in such a manner that a layer of the adhesive would give a thickness of 20 μm after dried. This workpiece was dried at 120° C. for 3 minutes to produce a test sample 1B. Another film MRF-38 was bonded also onto the adhesive layer surface. Without radiating light to the resultant, the gel fraction therein was measured. This was defined as the gel fraction before irradiation with light.

The test sample 1B was irradiated with light at 1.5 J/cm² from a metal halide UV lamp, and then subjected to dark reaction treatment (at 50° C. for 48 hours). The gel fraction in this sample was measured. This was defined as the gel fraction after the irradiation with the light.

### Examples 2 to 7, and Comparative Examples 1 to 4

In the same way as in Example 1, a composition described in Table 1 was used to prepare an adhesive layer and an adhesive attached polarizing plate sample of each of Examples 2 to 7 and Comparative Examples 1 to 4.

The samples obtained by these working examples and comparative examples were evaluated. The results are shown in Table 1.

TABLE 1

| | BA/MEA/HBA | 4HBAGE/2EHA | NCO | | Silane | UV | Storage elastic |
|---|---|---|---|---|---|---|---|
| | (part(s) by | (part(s) by | (part(s) by | Optical initiator | coupling agent | radiation | modulus Pa |
| | weight) | weight) | weight) | (part by weight) | (part by weight) | (J) | (at 23° C.) |
| Example 1 | 85/15/3 | 10/10 | 0.1 | 0.25 (E1064) | 0.1 | 1.5 | 1.08 × 10⁵ |
| Example 2 | 83/17/3 | 10/10 | 0.2 | 0.25 (E1064) | 0.1 | 1.4 | 1.10 × 10⁵ |
| Example 3 | 80/20/3 | 10/10 | 0.5 | 0.25 (E1064) | 0.1 | 1.5 | 1.07 × 10⁵ |
| Example 4 | 88/12/3 | 10/10 | 0.8 | 0.26 (E1064) | 0.1 | 1.0 | 1.11 × 10⁵ |
| Example 5 | 85/15/1 | 10/10 | 0.1 | 0.28 (E1064) | 0.1 | 1.2 | 1.05 × 10⁵ |
| Example 6 | 85/15/1 | 10/10 | 0.2 | 1.5 (SAN-APRO) | 0.1 | 1.2 | 2.32 × 10⁵ |
| Example 7 | 85/15/5 | 40/40 | 0.2 | 2 (SAN-APRO) | 0.1 | 1.2 | 7.25 × 10⁵ |
| Comparative | 100/0/3 | 10/10 | 0.2 | 0.12 (E1064) | 0.1 | 1.2 | 1.05 × 10⁵ |
| Example 1 | | | | | | | |
| Comparative | 95/5/3 | 10/10 | 0.1 | 0.12 (E1064) | 0.1 | 1.0 | 1.04 × 10⁵ |
| Example 2 | | | | | | | |
| Comparative | 50/50/3 | 10/10 | 0.1 | 0.12 (E1064) | 0.1 | 1.1 | 1.02 × 10⁵ |
| Example 3 | | | | | | | |
| Comparative | 85/15/3 | 10/10 | 2.0 | 0.14 (E1064) | 0.1 | 1.4 | 9.92 × 10⁴ |
| Example 4 | | | | | | | |

| | | Gel fractions | | | | | |
|---|---|---|---|---|---|---|---|
| | Storage elastic | ((%) before and | | | | | Unevenness |
| | modulus Pa | after the | | Heating | Humidifying | | (brightness |
| | (at 80° C.) | irradiation) | Haze | (at 90° C.) | (at 60/90%) | Contrast | ratio) |
| Example 1 | 1.09 × 10⁵ | 63.0/86.5 | 0.2 | ◯ | ◯ | 3321 | 1.8 |
| Example 2 | 1.12 × 10⁵ | 67.3/87.9 | 0.2 | ◯ | ◯ | 3310 | 1.9 |
| Example 3 | 1.09 × 10⁵ | 79.3/89.2 | 0.3 | ◯ | ◯ | 3260 | 1.7 |
| Example 4 | 1.13 × 10⁵ | 82.2/90.1 | 0.2 | ◯ | ◯ | 3255 | 1.8 |
| Example 5 | 1.06 × 10⁵ | 54.2/83.6 | 0.2 | ◯ | ◯ | 3260 | 1.7 |
| Example 6 | 2.52 × 10⁵ | 65.2/95.2 | 0.1 | ◯ | ◯ | 3240 | 1.7 |
| Example 7 | 7.45 × 10⁵ | 64.8/96.2 | 0.3 | ◯ | ◯ | 3240 | 1.6 |
| Comparative | 1.07 × 10⁵ | 73.2/79.5 | 4.5 | ◯ | ◯ | 2100 | 1.8 |
| Example 1 | | | | | | | |
| Comparative | 1.05 × 10⁵ | 69.2/78.2 | 3.2 | ◯ | ◯ | 2400 | 1.8 |
| Example 2 | | | | | | | |
| Comparative | 1.04 × 10⁵ | 66.3/79.5 | 4.2 | ◯ | ◯ | 2200 | 1.7 |
| Example 3 | | | | | | | |
| Comparative | 9.93 × 10⁴ | 83.2/87.8 | 0.3 | Δ | Δ | 3240 | 1.8 |
| Example 4 | | | | | | | |

1. An adhesive composition for optical applications, comprising 100 parts by weight of a modified (meth)acryl-based graft polymer, and 0.01 to 1.80 parts by weight of an isocyanate crosslinking agent,
wherein the modified (meth)acryl-based graft polymer is obtained by graft-polymerizing, to its trunk polymer, a chain that contains a cyclic-ether-group-containing monomer, and comprises an alkyl(meth)acrylate, the cyclic-ether-group-containing monomer, and an acyclic-ether-group-containing monomer as constituent components, and
in the modified (meth)acryl-based graft polymer, the acyclic-ether-group-containing monomer is contained in an amount of 8 to 40 parts by weight for 100 parts by weight of the whole of monomer components that constitute the trunk polymer and are different from the acyclic-ether-group-containing monomer.

2. The adhesive composition for optical applications according to claim 1, wherein in the modified (meth)acryl-based graft polymer, the acyclic-ether-group-containing monomer is contained in the trunk polymer.

3. The adhesive composition for optical applications according to claim 1, further comprising a photopolymerization initiator in an amount of 0.05 to 10 parts by weight for 100 parts by weight of the modified (meth)acryl-based graft polymer, or a thermosetting catalyst in an amount of 0.05 to 10 parts by weight therefor.

4. The adhesive composition for optical applications according to claim 1, further comprising a silane coupling agent in an amount of 0.01 to 5 parts by weight for 100 parts by weight of the modified (meth)acryl-based graft polymer.

5. The adhesive composition for optical applications according to claim 1, wherein the chain, which contains the cyclic-ether-group-containing monomer, is made from the cyclic-ether-group-containing monomer and one or more monomers different from the monomer, and the ratio of the amount of the cyclic-ether-group-containing monomer to the total amount of the different monomer(s) is from 90:10 to 10:90.

6. The adhesive composition for optical applications claim 1, wherein the modified (meth)acryl-based graft polymer is obtained by graft-polymerizing, to 100 parts by weight of the trunk polymer, 2 to 50 parts by weight of the cyclic-ether-group-containing monomer in the presence of 0.02 to 5 parts by weight of a peroxide.

7. An adhesive layer for optical applications, which is obtained from the adhesive composition for optical applications that is recited in claim 1.

8. A cured adhesive layer for optical applications, which is obtained by radiating an active energy ray to the adhesive layer for optical applications that is recited in claim 7, or applying heating treatment to the same adhesive layer for optical applications.

9. The cured adhesive layer for optical applications according to claim 8, having a gel fraction of 80 to 98% both inclusive.

10. The cured adhesive layer for optical applications according to claim 8, wherein the gel fraction after the curing by the radiation of the active energy ray or the application of the heating treatment is at least 6% higher than the gel fraction before the curing.

11. The cured adhesive layer for optical applications according to claim 8, which has a haze of 2.0 or less.

12. An adhesive layer attached optical member, wherein the adhesive layer for optical applications that is recited in claim 7.

13. An adhesive layer attached polarizing plate, which is formed by laying a protective layer, a polarizer, and the adhesive layer for optical applications that is recited in claim 7.

14. An adhesive layer attached polarizing plate, which is formed by laying a protective layer, a polarizer, a protective layer or a retardation layer, and the adhesive layer for optical applications that is recited in claim 7.

15. An image display device, comprising the adhesive layer attached polarizing plate recited in claim 13.

16. A lighting system, comprising the adhesive layer attached optical member recited in claim 12.

17. An adhesive layer attached polarizing plate, which is formed by laying a protective layer, a polarizer, and the adhesive layer for optical applications that is recited in claim 8.

18. An adhesive layer attached optical member, wherein the adhesive layer for optical applications that is recited in claim 8.

19. An image display device, comprising the adhesive layer attached polarizing plate recited in claim 17.

20. A lighting system, comprising the adhesive layer attached optical member recited in claim 18.
